(19) United States
(12) Patent Application Publication
(10) Pub. No.: US 2022/0063214 A1
(43) Pub. Date: Mar. 3, 2022

(54) METHOD FOR MANUFACTURING A COMPOSITE MATERIAL PART

(71) Applicant: SAFRAN, Paris (FR)

(72) Inventors: Sébastien Pierre Roger DUNAUD, Moissy-Cramayel (FR); Magali Mélanie COULAUD, Moissy-Cramayel (FR)

(21) Appl. No.: 17/415,225

(22) PCT Filed: Nov. 29, 2019
(86) PCT No.: PCT/FR2019/052850

§ 371 Date: Jun. 17, 2021

(30) Foreign Application Priority Data
Dec. 21, 2018 (FR) 1873868

(51) Int. Cl. B29C 70/34; B29C 70/54

(52) U.S. Cl. CPC B29C 70/342; B29K 2105/0872; B29C 70/544

(57) ABSTRACT

A method for manufacturing a part made from composite material includes the steps of: applying, to a tool, layers of prepreg composite material for constituting a preform; installing a cover on the preform and sealingly connecting this cover to the tool with sealant; applying a vacuum to the enclosure delimited by the cover and the tool containing the preform; and heating the assembly to a given temperature for a predetermined time period in order to polymerise the layers of prepreg composite material. Also, a step of applying at least one silicone patch to geometrically complex zones of the tool and/or the preform may be performed before installing the cover. The cover may include at least one polyimide and/or at least one compound from the phthalonitrile family.

### TECHNICAL FIELD

The present invention concerns the manufacture of composite material parts formed by stacking prepreg layers of fiber material placed on a tool forming a model to constitute a preform, and covered with a tarpaulin before vacuuming and heating the assembly to polymerise the preform.

### PRIOR ART

In FIG. 1, an installation 1 for manufacturing a composite material part, represented very schematically, shows a tool forming a box-shaped model 2 including lateral walls 3 and an upper wall 4, used to shape a layer stack 6 of prepreg material.

The stack 6 extends over the top wall 4 having the edges thereof folded over the lateral walls 3, and it constitutes, once installed as in FIG. 1, the preform of the part to be manufactured. In the case of FIG. 1, the part symbolically has a box shape, whose inner surface is delimited by the outer faces of the tool 2.

The stack 6 is formed of layers called prepreg layers, that is to say of fibrous fabric or arrangement, for example carbon fibers, prepreg with a polymerisable matrix, supplemented by masking elements. The polymerisation is typically obtained by heating to a given temperature for a predetermined duration.

In order to increase the mechanical strength of the part, the polymerisation is carried out by pressurising the stack 6, to minimize the matrix density and increase the fiber density. This pressurisation is ensured by covering the stack 6 with a tarpaulin 7, whose periphery is hermetically connected to the outer face of the tool 2, to delimit a sealed enclosure E around the stack 6.

In practice, the hermetic connection of the periphery of the tarpaulin 7 with the outer face of the tool 2 is obtained by interposing a sealant joint 8, and holding the tarpaulin 7 is ensured by screws 9, 11 jointly passing through this tarpaulin and the sealant joint 8 by being screwed through the tool 2.

The pressurisation of the stack 6 is obtained by establishing a vacuum in the enclosure E, the tool 2 including, for this purpose, a nozzle or a valve 12 for connection to a vacuum pump which is not represented.

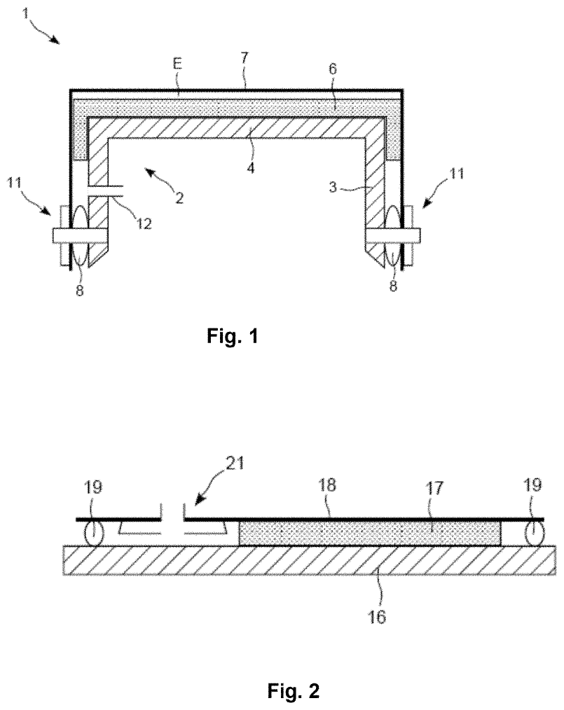

In the case of a generally planar part, illustrated schematically in FIG. 2, the arrangement which is similar comprises a generally flat tool 16 supporting a stack of layers 17 covered by a tarpaulin 18 whose edges are hermetically connected to the tool 16 by a sealant joint 19, without a screw for holding the tarpaulin.

In the case of FIG. 2, the valve identified by 21, for connecting to a vacuum pump which is not represented, equips the tarpaulin instead of equipping the tool.

In general, the evolution of the composite materials requires increasing the polymerisation temperature, while the temperature acceptable for the current tarpaulins is limited below the desired polymerisation temperatures. In practice, the current tarpaulins are resistant to 320° C. while the composite material called high temperature composite materials have a polymerisation temperature of 400° C., under 15 bars.

There are polyimide tarpaulins designed to withstand 400° C., but these tarpaulins are easily torn when used for the manufacture of a part of complex geometry such as that of FIG. 1, or when they should be pierced to install a valve as in the case of FIG. 2.

In this context, the aim of the invention is to provide a solution to carry out a vacuuming at a temperature above 320° C. to manufacture a part of complex geometry or to facilitate the integration of a valve in the case of a simple geometry.

### DISCLOSURE OF THE INVENTION

To this end, the invention relates to a method for manufacturing a composite material part, including the steps of:
applying, to a tool, layers of prepreg composite material to constitute a preform;
installing a tarpaulin on the preform and sealingly connecting this tarpaulin to the tool with sealant (34, 44);
vacuuming the enclosure delimited by the tarpaulin and the tool containing the preform;
heating the assembly to a given temperature for a predetermined duration to polymerise the layers of prepreg composite material (31, 38); characterised in that:
it includes a step of applying at least one remnant made of silicone or elastomer type material to at least one area of the tool and/or the preform having a complex geometry, prior to the installation of the tarpaulin (33, 46);
the tarpaulin is a tarpaulin comprising at least one polyimide and/or at least one compound of the family of phthalonitriles.

With this solution, the silicone or elastomer remnants soften the angular shapes, and they are in direct contact with the tarpaulin, such that they increase its mechanical strength in the areas of stress concentration where they are placed.

The invention also concerns a method thus defined, in which remnants made of silicone or elastomer type material reinforced with long fibers are used.

The invention also concerns a method thus defined, in which remnants made of silicone reinforced with glass fibers are used.

The invention also concerns a method thus defined, comprising prior to the installation of the tarpaulin, a step of equipping the tool with a valve equipping the tool, and of applying a remnant to the valve equipping the tool.

The invention also concerns a method thus defined, in which the valve includes a body and a connecting tube, in which the tarpaulin includes a hole for the passage of the connecting tube, and in which the remnant applied to the valve has dimensions greater than those of the body and includes a central hole for the centering and passage of the connecting tube.

The invention also concerns a method thus defined, in which the tool has the general shape of a box.

The invention also concerns a method thus defined, in which the tool has a generally planar shape.

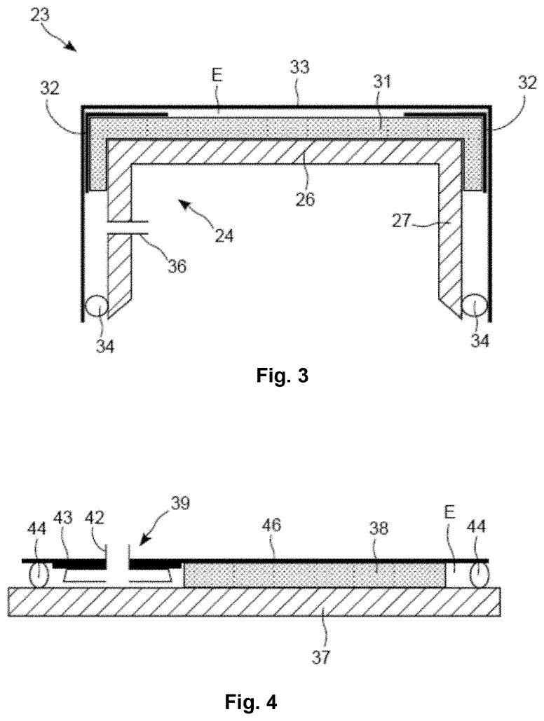

### BRIEF DESCRIPTION OF THE DRAWINGS

[FIG. 1] already described is a schematic representation showing an installation for manufacturing a composite part of complex geometry according to the state of the art;

[FIG. 2] already described is a schematic representation showing an installation for manufacturing a simple composite part with integration of a vacuum valve into the tarpaulin according to the state of the art;

[FIG. 3] is a schematic representation of the implementation of the invention to manufacture a high temperature composite part of complex geometry;

[FIG. 4] is a schematic representation of the implementation of the invention to manufacture a high temperature simple composite part with integration of a vacuum valve into the tarpaulin;

[FIG. 5] is a top view of the integration of a valve into a tarpaulin in accordance with the invention;

[FIG. 6] is a sectional view of the integration of a valve into a tarpaulin in accordance with the invention.

### DETAILED DESCRIPTION

The idea behind the invention is to implement two materials allowing synergistically avoiding the thermal degradation of one and increasing the mechanical resistance of the other. Concretely, the association of a polyimide tarpaulin with silicone remnants applied to the angular portions of the preform and/or the tooling allows constituting a vacuum bag withstanding a baking temperature of 400° C. under 15 bars, without risk of tearing or other degradation of this tarpaulin.

In FIG. 3, the installation 23 for manufacturing a composite material part includes a tool forming a model 24 comprising a generally planar upper wall 26 with a square or rectangular contour extended by lateral walls 27 disposed in a frame arrangement which surrounds the upper wall by extending it.

This tool 24 thus has the general shape of a box whose outer surface delimits the inner surface of a part to be manufactured. It in fact includes several angular portions, namely four ridges, two of which are identified by 28 and 29, as well as four vertices not visible in the sectional view represented by FIG. 3 which constitutes a geometry called complex geometry in this field.

During manufacture, layers of prepreg materials are stacked on the upper face of the wall 26 extending beyond the latter to protrude along the lateral walls 27 in order to constitute a preform of the part to be manufactured, this stack being identified by 31 in FIG. 3.

Additionally, masking elements which are not represented, locally covering some parts of the preform in order for example to locally change its thickness or shape therein, are added to the stack of prepreg layers.

According to the invention, the angular portions of the preform defined by the stack 31 and by the tool 24 are then locally covered by silicone remnants, identified by 32 in FIG. 3, so as to soften these angular shapes. These remnants thus allow limiting the stress concentrations of the tarpaulin which will then be installed, and thereby the risk of tearing or damage to this tarpaulin during the polymerisation cycle.

As shown in the Figure, the silicone remnants are placed in the areas likely to tear the polyimide tarpaulin, that is to say on the corners and angles of the part to be manufactured and/or the used tooling. The remnants herein are 120mm square, but their size and shape are conditioned by the anatomy and dimensions of the part to be manufactured.

Once the silicone remnants 32 have been put in place, a polyimide tarpaulin 33 is installed on the assembly formed by the tool 24 with the stack 31 as well as the masking elements which are not represented and the silicone remnants 32, and the edges of this tarpaulin are hermetically connected to the tool 16 by a sealant joint 34.

When all these components are completely configured, that is to say installed in the appropriate and controlled positions, the sealed enclosure E surrounding the stack 31 is vacuumed by means of a vacuum pump connected to a valve 36 equipping the tool 24.

This evacuation allows bringing the outer face of each silicone remnant into direct contact with the polyimide wall. Indeed, in the figures, the assembly is shown before vacuuming the enclosure E, but when the vacuum is created in the enclosure E, the tarpaulin conforms to the shape of the preform and the remnants, to adopt a shape in which it is fully bearing on these elements, the enclosure E then having a volume which is virtually zero.

During the process of vacuuming and heating, the silicone or elastomeric material remnants can thus be secured to the polyimide tarpaulin, helping to increase its mechanical strength in the areas of complex geometry, that is to say the areas generating a concentration of stresses in the tarpaulin.

In the example of the planar part, illustrated in FIG. 4, the tool 37 has a generally flat shape, and layers of prepreg materials are stacked on the upper face thereof in order to constitute a preform of the part to be manufactured, this stack being identified by 38. Herein too, masking elements which are not represented, can be added locally on some parts.

As shown in FIG. 4, a valve 39 is also installed in the vicinity of an edge of the stack 38 constituting the preform, being initially laid flat on the upper face of the tool 37.

As shown in more detail in FIGS. 5 and 6, this valve 39 includes a generally planar body 41 equipped with a connection tube 42 which protrudes perpendicularly from the body 41 thereof, this tube 42 being intended to pass through a corresponding hole of the tarpaulin to be able to be connected to the vacuum pump which is not represented.

In order to reinforce the area corresponding to the hole of the polyimide tarpaulin intended to be passed through by the tube 42, a silicone remnant 43, also including a central hole, is first directly mounted on to the upper face of the valve 39, namely the face which is opposite to the tarpaulin in FIG. 4, by protruding widely beyond the contours of the body 41. This remnant 43 thus allows softening the outer circular ridge of the body 41, to ensure that it cannot constitute a projecting portion likely to damage the tarpaulin.

Once the valve 39 is fully installed, a sealant joint 44 is applied to the upper face of the tool 37, all around the assembly consisting of the stack 38 and the valve 39 which is contiguous thereto.

When the assembly is ready, the polyimide tarpaulin 46, in which a hole has previously been formed for the tube 42, is applied to the assembly, by placing the tube in the hole, and so as to cover the stack 38 as well as the valve 39 and the sealant joint 44.

The silicone remnant 43 which covers the body of the valve is thus in direct contact with the polyimide tarpaulin when the vacuum is created in the enclosure E. The establishment of a vacuum in the enclosure delimited by the polyimide tarpaulin and the tool thus allows firmly pressing the polyimide tarpaulin against the silicone remnant 43. Thus, the remnants are secured to the tarpaulin to mechanically reinforce it in order to prevent it from tearing in the portion thereof which is weakened by the hole that the tube 42 passes through.

In general, the silicone remnants allow softening the projecting shapes of the preform and/or the used tooling, which allows limiting the stress concentrations of the tarpaulin when it is vacuumed. Moreover, bringing silicone into intimate contact with the tarpaulin pressing on the remnants allows jointly thermally protecting the remnants and mechanically reinforcing the strength of the polyimide tarpaulin by securing the remnants to the tarpaulin.

The used silicone remnants, also called patches, can advantageously be of the type reinforced with glass fibers, these remnants can be formed of portions of silicone tarpaulin reinforced with glass fibers.

In the example which has been described, the remnants are made of silicone, but remnants formed by any other elastomeric material, advantageously reinforced with long fibers, resistant to the required temperature may be suitable, according to the specific application which is made of the invention.

Moreover, the invention has been described for a polyimide tarpaulin, but applies to any tarpaulin comprising at least one polyimide and/or a compound of the family of phthalonitriles.

What is claimed is:

1-7. (canceled)

8. A method for manufacturing a composite material part, including the steps of:
applying, to a tool (24, 37), layers of prepreg composite material (31, 38) to constitute a preform;
installing a tarpaulin (33, 46) on the preform and sealingly connecting this tarpaulin (33, 46) to the tool (24, 37) with sealant (34, 44);
vacuuming the enclosure (E) delimited by the tarpaulin (33, 46) and the tool (24, 37) containing the preform;
heating the assembly to a given temperature for a predetermined duration to polymerise the layers of prepreg composite material (31, 38);
applying at least one remnant (32, 43) made of silicone or elastomer type material to at least one area of the tool (24, 37) and/or the preform having a complex geometry, prior to the installation of the tarpaulin (33, 46);
the tarpaulin (33, 46) is a tarpaulin comprising at least one polyimide and/or at least one compound of the family of phthalonitriles.

9. The method according to claim 8, wherein remnants (32, 43) made of silicone or elastomer type material reinforced with long fibers are used.

10. The method according to claim 8, wherein remnants (32, 43) made of silicone reinforced with glass fibers are used.

11. The method according claim 8, comprising prior to the installation of the tarpaulin, a step of equipping the tool with a valve (39) equipping the tool, and of applying a remnant (43) to the valve (39) equipping the tool.

12. The method according claim 11, wherein the valve (39) includes a body (41) and a connecting tube (42), wherein the tarpaulin includes a hole for the passage of the connecting tube (42), and wherein the remnant (43) applied to the valve (39) has dimensions greater than those of the body (41) and includes a central hole for the centering and passage of the connecting tube (42).

13. The method according to claim 1, wherein the tool (24) has the general shape of a box.

14. The method according to claim 1, wherein the tool (37) has a generally planar shape.
